(19) United States
(12) Patent Application Publication
(10) Pub. No.: US 2010/0040932 A1
(43) Pub. Date: Feb. 18, 2010

(54) FUEL CELL SEPARATOR PLATED WITH NICKEL AND ITS MANUFATURING METHOD

(76) Inventors: Joon Taik Suh, Kwangju-Shi (KR); Jung Hyeuk Suh, Seoul (KR); Yong Hun Lee, Kwangju-Si (KR)

Correspondence Address: COOPER & DUNHAM, LLP, 30 Rockefeller Plaza, 20th Floor, NEW YORK, NY, 10112, US

(21) Appl. No.: 12/312,905

(22) PCT Filed: Nov. 21, 2007
(86) PCT No.: PCT/KR2007/005851

§ 371 Date: May 29, 2009

(30) Foreign Application Priority Data
Dec. 1, 2006 (KR) 10-2006-0120312

(51) Int. Cl. H01M 2/16; B29C 43/00; C25D 5/56; B05D 1/00

(52) U.S. Cl. 429/34; 264/105; 205/164; 427/430.1

(57) ABSTRACT

A fuel cell separator, comprising carbonic electro-conductive graphite, and non-carbonic epoxy resin, hardening agent and hardening expediter, which are all made into powder, and formed into the fuel cell separator, wherein the fuel cell separator is plated with nickel by plating with nickel the surface of the fuel cell separator made through the process described above.

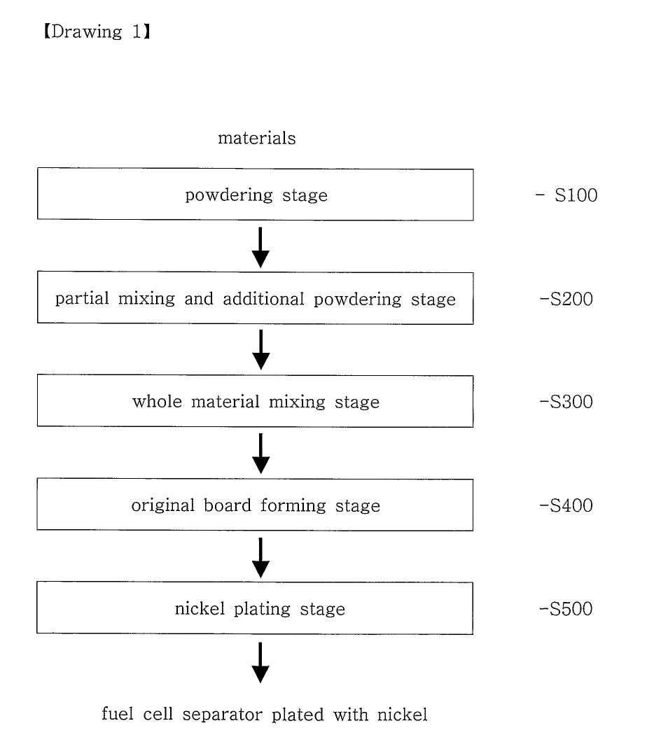

### FIELD OF TECHNOLOGY THE INVENTION BELONGS TO AND ITS PRIOR ART

This invention deals with the hydrogen and hydrogen compound fuel cell separator and its manufacturing method and seeks to provide such a hydrogen and hydrogen compound fuel cell separator as is highly performing, durable, cheap and mass-productible. In this invention, the separator is formed and then plated with nickel in a non-electrolytic way or in an electric way.

The hydrogen and hydrogen compound fuel cell (hereinafter, referred to as the fuel cell) utilizes hydrogen and oxygen in the air to produce both electric and heat energy. It is environmentally-friendly, discharging nothing other. than pure water. Plenty of research is going on it as a next-generation energy source when we are facing the depletion of such fossil fuel resources as oil and coal and stricter environmental regulations as in the Kyoto Protocol on Climate Change. In order that the fuel cell may be widely used, the components which occupy a large share of production cost, namely solid polymer membrane, platinum catalyst, separator, etc. should be provided at a cheaper price.

One prior art about the fuel cell separator suggested a method where a graphite board is manufactured in a mechanical process as introduced in the Japanese Patent Disclosure Comment No. 8-222241. But the method has a drawback of being fragile when the board has creases on its either side. Then it is not possible to make a separator which is thinner than 2.5 mm. To solve the problem, it should be heavier and, as a result, costs more. Another prior art, which was published in the Japanese Patent Disclosure No. 2001-335695 and the Korean Patent Disclosure Report No. 2003-0030885 suggested that thermosetting resin like electro-conductive carbonic material and epoxy resin be powdered to produce separators by the injecting or pressure-forming method. But, because they contain non-electro-conductive thermosetting resin, they have a weakness of being less efficient and less durable in comparison with those made by processing the graphite board mechanically. In an effort to overcome the drawback, the Korean Patent Registration No. 0533104 suggested that electrification preventing material be added before injecting or pressure -forming to enhance the performance of the separator. But, as carbon black acts as an electrification preventing agent, in reality even when carbon black is added, it can not improve the performance. Therefore, the problem of lesser performance of separators made through injecting or pressure -forming than mechanical manufacturing still exists.

### TECHNICAL TASK THE INVENTION SEEKS TO ACHIEVE

This invention was devised to solve the problems above and seeks to develop good forming materials and powderize them before making original separator boards by the injecting or pressure-forming method and then going through the process of plating the boards with nickel. In this way, the highly performing fuel cell separator plated with nickel and its manufacturing method are provided.

### COMPOSITION OF THE INVENTION

This invention is about the fuel cell separator whose surface is plated with nickel and its manufacturing method. Specifically, carbonic electro-xonductive graphite, and non-carbonic epoxy resin, hardening agent and hardening expediter, which are all made into powder, are formed into the fuel cell separator. The surface of the separator, then, is plated with nickel. The thickness of nickel plating measures should be more than 10 μm. and less than 50 μm.

In this invention, the fuel cell separator plated with nickel has between 60 weight % and 80 weight % of carbonic electro-conductive graphite, and between 15 weight % and 40 weight % of non-carbonic materials like epoxy resin, hardening agent and hardening expediter. Furthermore, the average spheric diameter of the carbonic electro-conductive graphite should be more than 30 μm. and less than 50 μm. In addition, the original fuel cell separator board may contain the following reinforcing materials out of the 100 weight % of the electro-conductive carbonic graphite and the non-carbonic matter described above: 0.5-1 weight % of carbon black; aerosil made up of 0.5-1 weight % of SiO₂; and 0.5-1.5 weight % of bone powder or clam shell powder.

To explain this invention in detail, the fuel cell separator board is made of electro-conductive carbonic material like natural or artificial graphite which allows for heat and electricity transfer; thermosetting resin like epoxy resin or phenol resin which facilitates forming and fixates electro-conductive carbonic material; and powdered materials of hardening expediter, aerosil and reinforcing matter. The ratio of electro-conductive carbonic material should be between 60 weight % and 85 weight % because, if the ratio is less than 60 weight %, the strength and durability of the separator improves but electro-conductivity suffers, and if the ratio is more than 85 weight %, electro-conductivity improves but strength and durability suffers.

Among carbonic electro-conductive materials used in forming the separator board, graphite is best and materials like acetylene black are not suitable because they have trouble permeating hydrogen owing to big pores. And, carbonic electro-conductive materials are made into powder, whose average spherical diameter should be between 30 μm and 50 μm. Either artificial or natural graphite is good.

On the other hand, the separator board can not be made by forming powdered graphite only. So, thermosetting resin powdered is mixed with graphite before forming. Considering that heat along with electricity is produced when fuel cell is in operation, thermosetting resin which is resistant to heat and strong should be used. Usually epoxy resin is used. Bisphenol A type or novolac type is good and should be capable of being made into powder.

Hardening agent is necessary in order to harden epoxy resin which is used in manufacturing the separator board. Among various hardening materials, phenol resin varieties are good and should have burning points high enough to allow powder making.

Hardening expediters are indispensable because they play the role of increasing production speed by shortening the gell time in the course of the fuel cell separator manufacturing. Among many hardening materials, organic phosphorus varieties are good and should be capable of being made into powder.

The size of carbon black should be less 5 nm and should occupy 1-2 weight % of the 100 weight % of the electro-conductive carbonic graphite and the non-carbonic matter described above, thereby inhibiting hydrogen permeability.

The 5 nm powder of SiO₂ is used for aerosil. It along with carbon black inhibits hydrogen permeability, and, when forming the fuel cell separator, provides thixotropic property to resin and hardening materials, thereby preventing graphite from being separated from liquefied resin and hardening materials that are caused by high temperature and pressure. The amount of aerosil added should be 0.5-1 weight % of the 100 weight % of the electro-conductive carbonic graphite and the non-carbonic matter described above. In addition, one or both of bone powder and clam shell powder can be used to reinforce the separator board in order to improve the bending strength of the original separator board. The weight % of reinforcing materials should be 0.5-1 weight % of the 100 weight % of the electro-conductive carbonic graphite and the non-carbonic matter described above.

When the separator board is formed with the powdered materials as described above, the original board gets plated with nickel. The reason why the board is plated with nickel is that it is possible to improve electro--conductivity and the durability of the board itself. Because graphite, which is the major ingredient of the board, is not corrosive, it can have higher adhesiveness than a plated metal board. In addition, even when part of the board is damaged, the surroundings do not get corroded.

When plating with nickel, it is desirable to plate the board in the thickness of between 10 μm and 50 μm. If the plating is less than 10 μm, electro-conductivity suffers and, if it is more than 50 μm, it becomes less economical without further improving electro-conductivity.

The other invention in this application is the manufacturing method of the fuel cell separator plated with nickel. It involves the following stages: The stage where electro-conductive graphite, and non-carbonic epoxy resin, hardening agent and hardening expediter are powdered (S1OO); the partial mixing stage where electro-conductive graphite, epoxy resin and hardening material are mixed up by heating and additional powdering takes place (S200); the mixing-altogether stage where partially mixed and additionally powdered materials are mixed up again with hardening expediter added (S300); the forming stage where the original fuel cell separator is made by putting powdered materials into a mold(S400); and the plating stage where the original board is plated with nickel (S500). When the board is plated, either non-electrolytic or electric plating can be used.

Taking advantage of drawings, the fuel cell separator plated with nickel can be explained in the following way.

Drawing 1 depicts the whole process in which the fuel cell separator plated with nickel is manufactured,

As is explained in the above, all the forming materials—graphite, thermosetting resin, hardening agent, hardening expediter, aerosil, carbon black and reinforcing material—should be ground into powder.

Next, in order that graphite may be well mixed up with non-carbonic resin, partial mixing should be performed. Therefore, 50 weight % of graphite and 10 weight % of epoxy resin should be combined and then 25 weight % of graphite and 8 weight % of hardening agent should combined to be mixed up under heat. If partial mixing is not done, hardening reaction makes it difficult to determine a forming temperature and causes some problems in production because taking out boards out of molds is not easy. When partial mixing is finished, it is desirable to powderize the materials again or to add other materials before grinding them one more time.

After partial mixing and additional powdering take place, the powder should be mixed up using a kneader. The Hensel kneader is recommendable,

The next step is to put the powder material into the separator board mold which is designed to make creases on the surface of the separator so that hydrogen or air can pass. If the material goes through the forming process under the pressure of 700 kg/cm²-1500 kg/cm² and the temperature of 180° C.-300° C. and for 1-3 minutes before being cooled, the original separator is manufactured. The next thing to do is to plate the original board evenly with nickel by either non-electrolytic plating or electric plating method. When plating the board with nickel, it is desirable to use the method of non-electrolytic plating, which is called chemical plating or self-catalyst plating. In this method, reductants like formaldehyde or hydrogen in an aqueous solution provides electrons so that metal ions get reduced to metal molecules. This reaction takes place on the surface of the catalyst. The most commercialized plating materials are copper, nickel-phosphorus and nickel-boron alloy. In comparison with electric plating, non-electrolytic plating can produce a plating which is dense and has an even thickness of between 15 μm and 50 μm. In addition, the method can plate not only conductive materials but also a variety of boards like plastic or organic matter with good results.

Besides the non-electrolytic method described above, the electric plating can do the job of gilding the separator. When the nickel-plating process is finished, the end product of this invention or the fuel cell separator plated with nickel is finally made.

### BRIEF DESCRIPTION OF DRAWINGS

Drawing 1 outlines the whole process of production by which the fuel cell separator plated with nickel are manufactured. The first stage of S1OO is a process where each material is powdered.

The second stage of S200 has two processes: materials are mixed up under heat and pressure, and then they are again powdered.

The third stage of S300 is a process where all the materials are mixed up.

The fourth stage of S400 is a process where original boards are formed.

The fifth stage of S500 is the last and important process where the boards are plated with nickel, which makes them highly performing.

### BEST MODE FOR CARRYING OUT THE INVENTION

The following comparison examples and practice examples are designed to facilitate understanding this invention. If we make the fuel cell separator by forming or injecting the powdered material into boards, the thickness of the boards can be as thin as 0.8 mm, but to be equipped with the jet mill, the Hensel mixer, a top-quality pressure-forming press and an mold with creases which are precise is costly. So, the following examples were performed with fuel cell separators that measure 100 mm×100 mm×2 mm(L×W×D) and that has creases of 0.5 mm depth.

### COMPARISON EXAMPLE 1

First, put 75 weight % of graphite and 25 weight % of resins into a ball mill and grind them into powder of 30 μm diameter. Then put the powder into a mold that measures 100 mm×100 mm×2 mm(L×W×D) and that has creases of 0.5 mm depth before forming under the pressure of 800 kg/cm² and the temperature of 180° C. and for 90 seconds to produce fuel cell separators with a bending strength of 2500 psi, an electro-conductivity of 70 S/cm and a heat morphosis temperature of 180°.

### PRACTICE EXAMPLE 1

First, put 75 weight % of graphite and 25 weight % of resins into a ball mill and grind them into powder of 30 μm diameter. Then put the powder into a mold that measures 100 mm×100 mm×2 mm(L×W×D) and that has creases of 0.5 mm depth before forming under the pressure of 800 kg/cm² and the temperature of 180° C. and for 90 seconds to produce fuel cell separators plated with nickel that have a bending strength of 2800 psi, an electro-conductivity of 250 S/cm and a heat morphosis temperature of 198° C. The boards were plated 15 μm with nickel using non-electrolytic plating method.

### COMPARISON EXAMPLE 2

First, put 50 weight % of graphite and 10 weight % of epoxy resin into a ball mill and grind them into powder of 30 μm diameter. Then put the powder into a kneader and mix and cool it under the pressure of 5 kg/cm² and the temperature of 100° C. and for 80 seconds. Next, grind 25 weight % of graphite and 8 weight % of phenol resin as a hardening agent into powder of 30 μm diameter before putting it into a pressure kneader to mix it up under the pressure of 5 kg/cm² and the temperature of 100° C. and for 80 seconds and to cool. We put the two kinds of powder above into a ball mill and added 5 weight % of hardening expediter, 0.5 weight % of carbon black, 0.5 weight % of aerosil and 1 weight % of bone powder before mixing up and grinding them into powder of 30 μm diameter. Then, we put the powder into a mold that measures 100 mm×100 mm×2 mm(L×W×D) and that has creases of 0.5 mm depth before forming under the pressure of 800 kg/cm² and the temperature of 180° C. and for 90 seconds to produce fuel cell separators that have a bending strength of 3500 psi, an electro-conductivity of 90 S/cm and a heat morphosis temperature of 198° C.,

### (PRACTICE EXAMPLE 2)

After making fuel cell separators as in the comparison example 2 above, we plated nickel over the board surface with a thickness of 15 μm by non-electrolytic plating method and produced fuel cell separators plated with nickel with a bending strength of 3800 psi, an electro-conductivity of 250 S/cm and a heat morphosis temperature of 198° C.

As the practice samples above illustrate, if graphite and resin are mixed up under heat and nickel is plated onto the boards by either non-electrolytic or electric method, the strength and electro-conductivity of the fuel cell separator are shown to get greatly better.

We have described only desirable, specific examples in the above, but it is evident to workers in the field of technology that there can be a variety of transformations and modifications within the scope of this invention's ideas based on the concrete examples of this invention. In addition, those transformations and modifications naturally belong to the scope of the claims attached below.

### EFFECT OF THE INVENTION

As in the above, if graphite and thermosetting resin, and graphite and hardening agent are ground and partially mixed up and then the whole materials are ground up again to be formed into fuel cell separators and to be plated with nickel, the separator boards not only do not lose any electro-conductivity but also reduce the thickness and weight of the boards drastically compared with fuel cell boards made through mechanical cutting process.

This invention also can provide the fuel cell separator plated with nickel which is durable, cheap and mass-producible by being able to manufacture it not by cutting method but by pressure-forming or injection-forming method.

1. A fuel cell separator, comprising carbonic electro-conductive graphite, and non-carbonic epoxy resin, hardening agent and hardening expediter, which are all made into powder, and formed into the fuel cell separator, wherein the fuel cell separator is plated with nickel by plating with nickel the surface of the fuel cell separator made through the process described above.

2. A fuel cell separator as recited in claim 1, wherein the fuel cell separator plated with nickel, whose plated thickness is between 10 μm and 50 μm.

3. A fuel cell separator as recited in claim 2, wherein an original separator board contains more than 60 weight % and less than 85 weight % of carbonic electro-conductive graphite, and more than 15 weight % and less than 40 weight % of non-carbonic materials like epoxy resin, hardening agent and hardening expeditor and wherein the fuel cell separator is plated with nickel in which the size of carbonic electro-conductive graphite is between 30 μm and 50 μm.

4. A fuel cell separator as recited in claim 3, wherein, the fuel cell separator is plated with nickel, whose carbon black ratio is between 0.5 weight % and 1 weight % out of the whole 100 weight % of carbonic electro-conductive graphite and non-carbonic materials described respectively above, and whose SiO2 aerosil ratio is between 0.5 weight % and 1 weight % out of the whole 100 weight % of carbonic electro-conductive graphite and non-carbonic materials described respectively above, and whose reinforcing material is between 0.5 weight % and 1.5 weight % out of the whole 100 weight % of carbonic electro-conductive graphite and non-carbonic materials described respectively, wherein the reinforcing material is made of one or both of bone powder and clam shell powder.

5. A manufacturing method involved in making a fuel cell separator plated with nickel, which goes through the following stages, comprising:
a stage where electro-conductive graphite, and non-carbonic epoxy resin, hardening agent and hardening expediter are powdered;
a partial mixing stage where electro-conductive graphite, epoxy resin and hardening material are mixed up by heating and additional powdering takes place;
a mixing-altogether stage where partially mixed and additionally powdered materials are mixed up again with hardening expediter added;
a forming stage where the original fuel cell separator is made by putting powdered materials into a mold; and
a plating stage where the original board is plated with nickel.

6. The manufacturing method as recited in claim 5, wherein the nickel plating stage is performed by either non-electrolytic or electric plating method.
